(19) United States
(12) Patent Application Publication
(10) Pub. No.: US 2005/0000978 A1
(43) Pub. Date: Jan. 6, 2005

(54) Washer positioning device for roofing washer dispensers

(76) Inventor: Chen-Fa Huang, Ta Li City (TW)

Correspondence Address: Alan D. Kamrath;Rider Bennett, LLP, Suite 2000, 333 South Seventh Street, Minneapolis, MN, 55402, US

(21) Appl. No.: 10/612,519

(22) Filed: Jul. 2, 2003

(51) Int. Cl. B65G 59/00; B65H 1/08; G07F 11/16

(52) U.S. Cl. 221/279

(57) ABSTRACT

A positioning device for a roofing washer dispenser includes a plurality of protrusions extending from an inner periphery of the hole defined through a plate connected to the dispenser. A feeding device has a pushing plate which is movably engaged with the groove so as to feed a washer in the groove into the hole. The protrusions are located at an intermediate point of a width of the inner periphery of the hole so that the washer can be supported by the protrusions before it is penetrated by the nail.

### FIELD OF THE INVENTION

The present invention relates to a washer position device for a roofing washer dispensers wherein the hole located beneath of the nose of the dispenser includes a plurality of protrusions for positioning the washer in the hole.

### BACKGROUND OF THE INVENTION

A conventional roofing washer positioning device for roofing washer dispensers is disclosed in FIGS. 9 and 10 and generally a plate 100 which is located perpendicular to the nose of the roofing washer dispenser (not shown) and a groove 101 is defined in a top of the plate 100 so that a washer 200 can be moved in the groove 101 by a feeding device 300. A hole 102 is defined through an end of the plate 100 and washer positioning device is including a torsion plate 400 is located beside the hole 102 and a section of the torsion plate 400 is inserted in the hole 102. When the washer 200 is pushed to be engaged with the hole 102, the torsion plate 400 is pushed and generates a force to the washer 200 so as to keep the washer 200 in position and not to drop from the hole 102. The washer 200 is then penetrated by a nail ejected from the nose of the dispenser. The torsion plate 400 tends to be loose its expected torsion force after being used for a period of time and the washer 200 in the hole 102 is not securely urged by the torsion plate 400 so that the nail could not penetrate the washer 200 at the desired position. Besides, it takes a lot of time to install the torsion plate 400.

The present invention intends to provide a washer positioning device for a roofing washer dispensers and includes a plurality of protrusions extending from an inner periphery of the hole of the plate.

### SUMMARY OF THE INVENTION

In accordance with one aspect of the present invention, there is provided a roofing washer dispenser which comprises a barrel having a nose on a distal end thereof and a magazine for storing nails therein is connected to the barrel. A tube is connected to the barrel and a pile of washers are received in the tube. A plate is connected to the barrel and including a groove defined in a top of the plate. A hole is defined through the plate and located beneath of the nose. A feeding device has a pushing plate which is movably engaged with the groove so as to push a washer in the groove into the hole. A plurality of protrusions extend from an inner periphery of the hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the roofing washer dispenser with the washer positioning device of the present invention;

FIG. 2 is an enlarged view to show the protrusions on the inner periphery of the hole;

FIG. 3 is a side cross sectional view to show the roofing washer dispenser with the washer positioning device of the present invention;

FIG. 4 is an enlarged view to show the nose and the protrusions on the inner periphery of the hole;

FIG. 5 is a top view to show a washer is to be pushed to the hole;

FIG. 6 is a top view to show that a washer is located in the hole;

FIGS. 7 and 8 show that the nose is lowered to push the washer in the hole;

FIG. 9 is a top view to show a washer is to be pushed into a hole and a conventional positioning device is located beside the hole, and

FIG. 10 is a top view to show the washer as shown in FIG. 9 is pushed into a hole and urged by the torsion plate.

### DETAILED DESCRIPTION OF THE PREFERRED EMBODIMENT

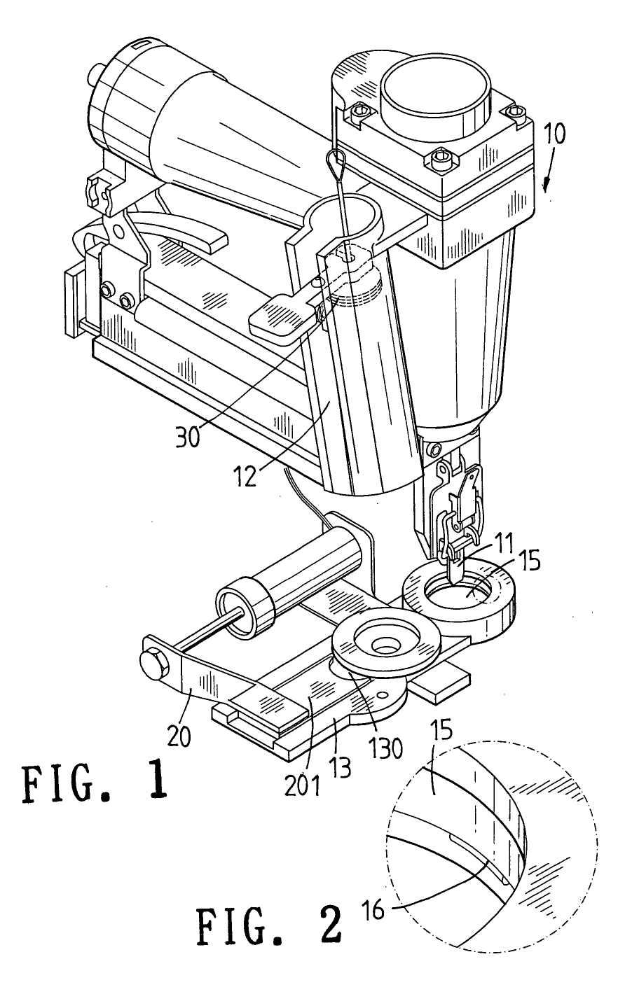

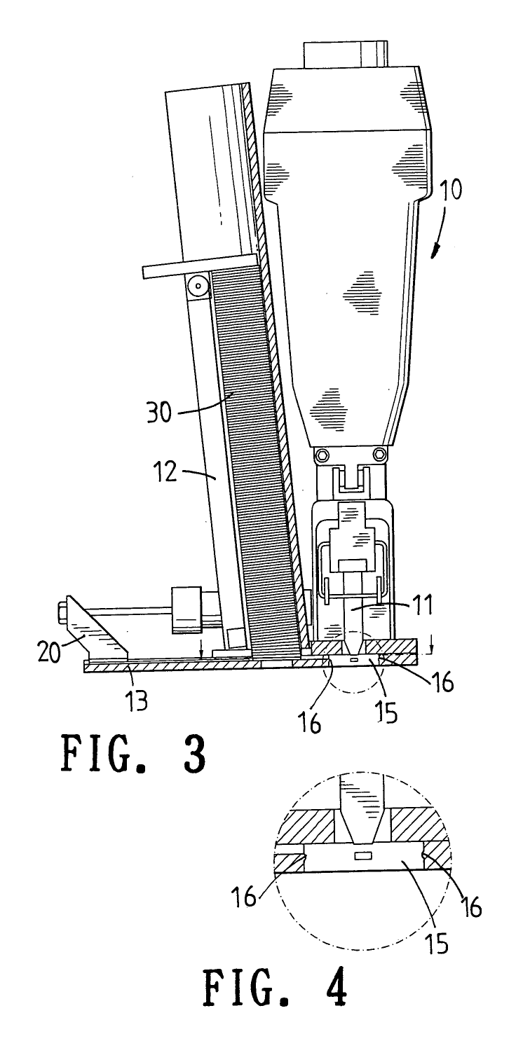

Referring to FIGS. 1 to 4, the roofing washer dispenser of the present invention comprises a barrel 10 with a handle which is able to be connected to a hose so as to provide pneumatic force in the barrel 10. A nose 11 is located on a distal end of the barrel 10 and a magazine for storing nails is connected to the barrel 10. A tube 12 is connected to the barrel 10 and a pile of washers 30 is received in the tube 12. A plate 13 is connected to the barrel 10 and includes a groove 130 defined in a top of the plate 13. A hole 15 is defined through the plate 13 and located beneath of the nose 11. A feeding device 20 includes a pneumatic cylinder and a pushing plate 201 is connected to the pneumatic cylinder so that the pushing plate 201 is movably engaged with the groove 130. At least one washer 30 in the groove 130 is pushed by the pushing plate 201 toward the hole 15.

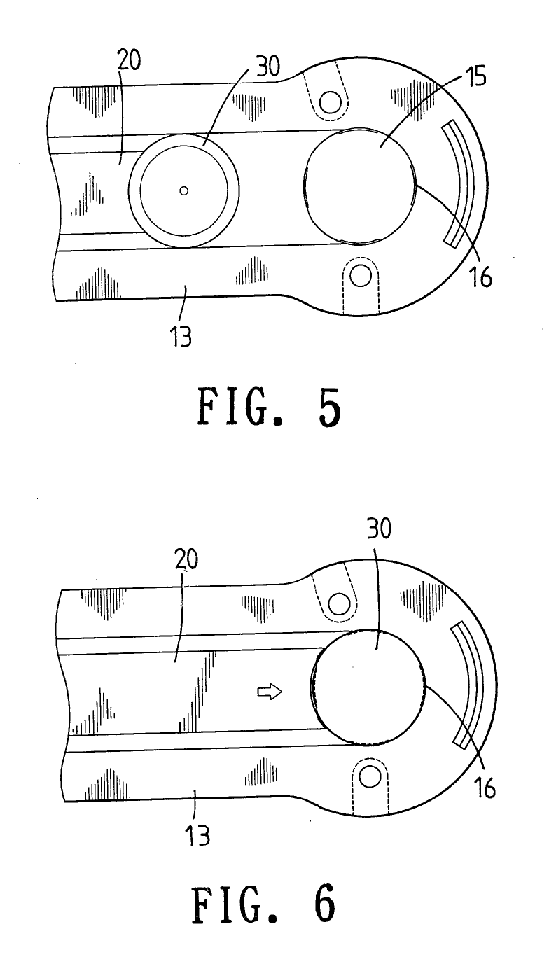

Further referring to FIGS. 5 and 6, the roofing washer positioning device includes a plurality of protrusions 16 extending from an inner periphery of the hole 15. The protrusions 16 are located at an intermediate point of a width of the inner periphery of the hole 15 so that when the washer 30 is pushed by the pushing plate 201 and enter the hole 15, the washer 20 is supported by the protrusions 16 and will not drop out from the hole 15.

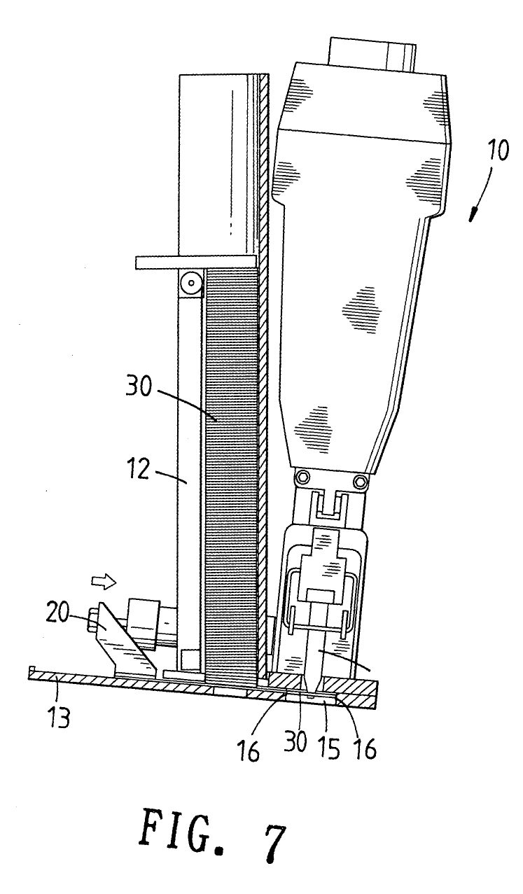

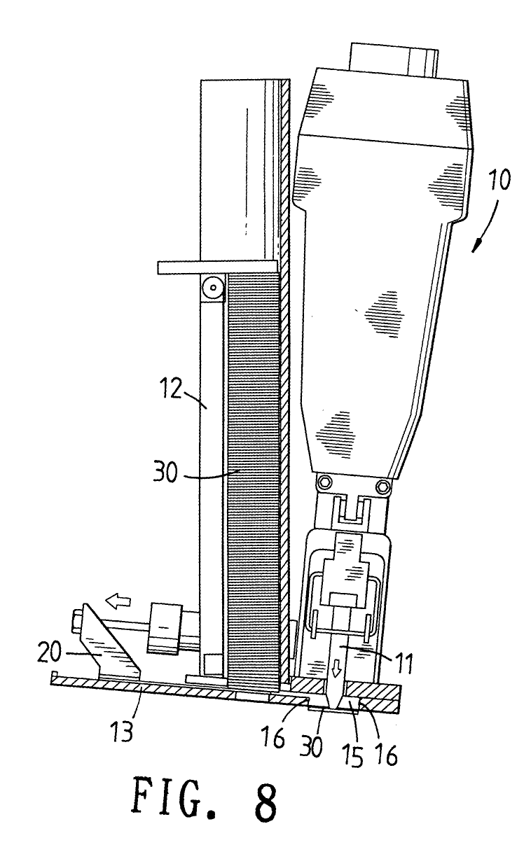

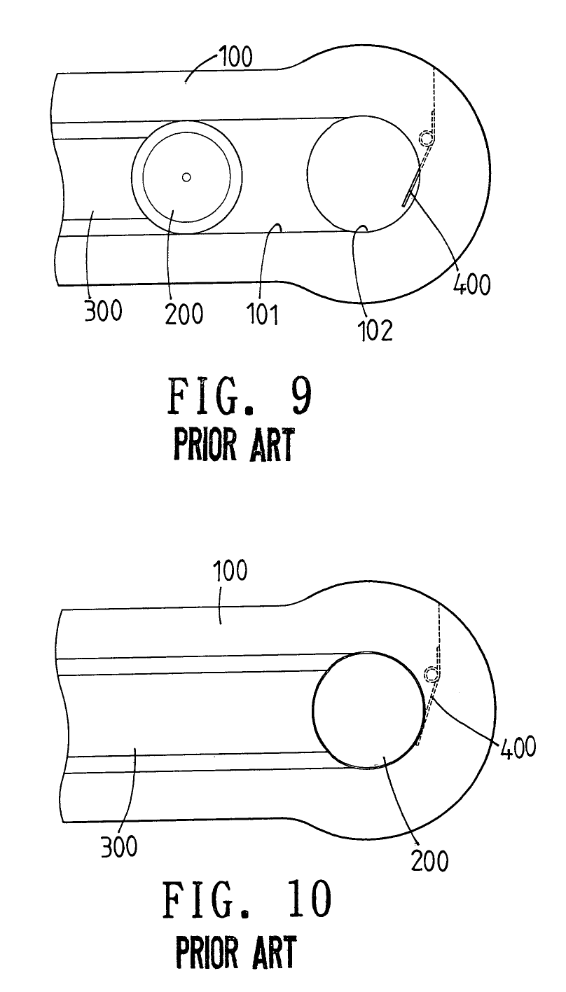

Referring to FIGS. 7 and 8, when the nose 11 is lowered, the washer 30 supported by the protrusions 16 is pushed by the nose 11 and forced to move over the protrusions 16 and a nail (not shown) penetrates through the washer from the nose 11.

The protrusions 16 are easily made integrally with the hole 15 and can be used for a much longer period of time than the torsion plate as disclosed in the conventional positioning device.

While we have shown and described the embodiment in accordance with the present invention, it should be clear to those skilled in the art that further embodiments may be made without departing from the scope of the present invention.

1. A roofing washer dispenser comprising:
a barrel having a nose on a distal end thereof and a magazine connected to the barrel, a tube connected to the barrel and a pile of washers received in the tube, a plate connected to the barrel and including a groove defined in a top of the plate, a hole defined through the plate and located beneath of the nose, a feeding device having a pushing plate which is movably engaged with the groove, at least one washer in the groove and pushed by the pushing plate, and
a plurality of protrusions extending from an inner periphery of the hole.

2. The roofing washer dispenser as claimed in claim 1, wherein the protrusions are located at an intermediate point of a width of the inner periphery of the hole.
